(19) United States
(12) Patent Application Publication
(10) Pub. No.: US 2015/0309636 A1
(43) Pub. Date: Oct. 29, 2015

(54) SENSOR-EQUIPPED DISPLAY DEVICE

(71) Applicant: Japan Display Inc., Tokyo (JP)

(72) Inventors: Hayato KURASAWA, Tokyo (JP); Koji NOGUCHI, Tokyo (JP); Koji ISHIZAKI, Tokyo (JP)

(21) Appl. No.: 14/691,177

(22) Filed: Apr. 20, 2015

(30) Foreign Application Priority Data
Apr. 25, 2014 (JP) 2014-091614

(51) Int. Cl. G06F 3/041; G06F 1/16

(52) U.S. Cl. CPC G06F 3/0412; G06F 1/16; G06F 2203/04107

(57) ABSTRACT

According to one embodiment, a sensor-equipped display device includes a display panel includes at least a substrate and a sensor in a detection electrode including a transparent conductive layer. The transparent conductive layer includes a plurality of first regions in a crystalline state and a plurality of second regions in an amorphous state that are mixed therein.

### CROSS REFERENCES TO RELATED APPLICATIONS

The present application claims priority to Japanese Priority Patent Application JP 2014-091614 filed in the Japan Patent Office on Apr. 25, 2014, the entire content of which is hereby incorporated by reference.

### BACKGROUND

Recently, a sensor-equipped display device comprising a sensor (often called a touchpanel) configured to detect contact or close proximity of an object has been put into practical use. One of examples of the sensor is an electrostatic capacitance type sensor capable of detecting contact or close proximity of a conductor such as a finger, based on variation in electrostatic capacitance. A detection electrode and a sensor driving electrode constituting such a sensor are opposed to each other via a dielectric member.

### SUMMARY

Embodiments described herein relate generally to a sensor-equipped display device.

Additional features and advantages are described herein, and will be apparent from the following Detailed Description and the figures.

### BRIEF DESCRIPTION OF THE FIGURES

FIG. 1 is a perspective view schematically showing a structure of a sensor-equipped liquid crystal display device of a first embodiment.

FIG. 2 is a diagram schematically showing a basic structure and an equivalent circuit, of the liquid crystal display device shown in FIG. 1.

FIG. 3 is an equivalent circuit diagram showing a pixel shown in FIG. 2.

FIG. 4 is a cross-sectional view schematically showing the structure in part of the liquid crystal display device.

FIG. 5 is a plan view schematically showing a structure of a sensor in the first embodiment.

FIG. 6 is a cross-sectional view schematically showing a structure of a liquid crystal display panel including the sensor in part.

FIG. 7 is an illustration for explanation of a principle of an example of a sensing method.

FIG. 8 is an illustration showing a plurality of first regions in a crystalline state and a plurality of second regions in an amorphous state, indicating a result of SEM-EBSD analysis executed for the transparent conductive layer of the first embodiment.

FIG. 9 is a table showing, in a case where a crystallization area rate of a transparent conductive layer of a sensor-equipped liquid crystal display device of a second embodiment is varied, (1) an average value of a size of crystallized grains in the transparent conductive layer, (2) a first evaluation based on a reliability test, and (3) a second evaluation on a state of the transparent conductive layer.

FIG. 10 is a table showing in a case where an average value of a size of crystallized grains in a transparent conductive layer of a sensor-equipped liquid crystal display device of a third embodiment is varied, (1) a crystallization area rate in the transparent conductive layer, (2) a first evaluation based on a reliability test, and (3) a second evaluation on a state of the transparent conductive layer.

FIG. 11 is a cross-sectional view schematically showing a structure of a sensor-equipped liquid crystal display device of a fourth embodiment.

FIG. 12 is a schematic plan view showing a part of a sensor-equipped liquid crystal display device of a fifth embodiment, illustrating a plurality of detection electrodes, a shielding electrode and an OLB pad group.

FIG. 13 is a schematic cross-sectional view showing the liquid crystal display device shown along line XIII-XIII in FIG. 12.

FIG. 14 is an enlarged plan view showing a part of the liquid crystal display panel shown in FIG. 12, illustrating the detection electrode and a plurality of dummy electrodes.

FIG. 15 is a table showing, in a case where an average potential of the detection electrodes and an average potential of the shielding electrode in the sensor-equipped liquid crystal display device of the fifth embodiment are varied, (1) a difference between the average potential of the detection electrodes and the average potential of the shielding electrode, (2) a first evaluation, (3) a second evaluation, and (4) a final evaluation.

### DETAILED DESCRIPTION

In general, according to one embodiment, there is provided a sensor-equipped display device comprising: a display panel comprising at least a substrate; and a sensor comprising a detection electrode including a transparent conductive layer, wherein the transparent conductive layer includes a plurality of first regions in a crystalline state and a plurality of second regions in an amorphous state that are mixed therein.

Embodiments of the present invention will be described hereinafter with reference to the accompanying drawings. The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc. of the respective parts are schematically illustrated in the drawings, compared to the actual modes. However, the schematic illustration is merely an example, and adds no restrictions to the interpretation of the invention. In the specification and drawings, the same elements as those described in connection with preceding drawings are denoted by like reference numerals, and a detailed description thereof is omitted unless otherwise necessary.

First, the basic concept of the embodiments is described.

A sensor-equipped display device comprises a display panel, a polarizer and a sensor, and is configured to detect data input from a display surface side by input means. The sensor is an electrostatic capacitance type sensor. A detection electrode of the sensor is positioned between a substrate of the display panel and the polarizer. The detection electrode is formed of a transparent conductive material. As such a transparent conductive material, for example, indium tin oxide (ITO), indium zinc oxide (IZO) or zinc oxide (ZnO) is used. As the input means, a conductor such as a pen (stylus) and a human body can be used. The display device can thereby detect position information of a portion on the input surface of the display device with which a finger, etc. are in touch or to which a finger, etc. are in close proximity.

Incidentally, a transparent conductive layer having an entire region formed of an amorphous transparent conductive material can be used as the detection electrode. In this case, however, a detection electrode having a high electric resistance and a poor resistance to corrosion is formed. For this reason, if a transparent conductive layer having an entire region formed of a polycrystalline transparent conductive material is used as the detection electrode, a detection electrode having a strong resistance to corrosion can be obtained. The electric resistance of the detection electrode can also be lowered.

However, the polycrystalline transparent conductive layer is very hard as compared with the amorphous transparent conductive layer. Thus, fracture (crash) and corrosion can easily occur on the detection electrode using the polycrystalline transparent conductive layer. For example, fracture, etc. of the detection electrode may easily occur when a stress generated by contraction of the polarizer affects the detection electrode for a long time.

In addition, unevenness on the surface may become great and ion components contained in a bonding layer of the polarizer may locally exist at uneven portions, in the polycrystalline transparent conductive layer. In this case, there is a risk that the ion components may cause the corrosion of the polycrystalline transparent conductive layer.

Considering the above-described problems, means and methods for solving the problems will be hereinafter described.

### First Embodiment

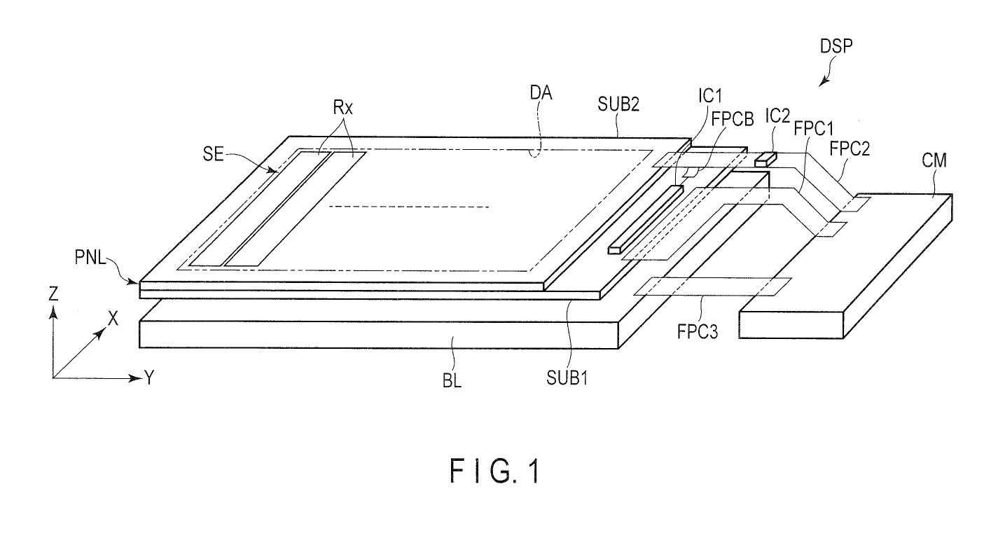

A sensor-equipped display device of a first embodiment will be hereinafter described in detail with reference to the accompanying drawings. In the present embodiment, the display device is a liquid crystal display device. FIG. 1 is a perspective view schematically showing a structure of the sensor-equipped liquid crystal display device of the present embodiment.

As shown in FIG. 1, a liquid crystal display device DSP comprises an active matrix type liquid crystal display panel PNL, a driver IC chip IC1 which drives the liquid crystal display panel PNL, an electrostatic capacitance type sensor SE, a driver IC chip IC2 which drives the sensor SE, a backlight unit BL which illuminates the liquid crystal display panel PNL, a control module CM, flexible wiring boards FPC1, FPC2, FPC3, etc.

The liquid crystal display panel PNL comprises a flat-panel first substrate SUB1, a flat-panel second substrate SUB2 disposed opposite to the first substrate SUB1, and a liquid crystal layer (a liquid crystal layer LQ to be described later) held between the first substrate SUB1 and second substrate SUB2. In this embodiment, the first substrate SUB1 may be restated as an array substrate, and the second substrate SUB2 may be restated as a counter-substrate. The liquid crystal display panel PNL includes a display area (active area) DA on which an image is displayed. The liquid crystal display panel PNL is a transmissive type display panel having a transmissive display function which displays images by selectively transmitting backlight from the backlight unit BL. The liquid crystal display panel PNL may be a transflective type liquid crystal display panel having a reflective display function which displays images by selectively reflecting outside light besides the transmissive display function.

The backlight unit BL is disposed on a back surface side of the first substrate SUB1. As the backlight unit BL, various types of units are applicable, and a backlight unit using a light-emitting diode (LED) as a light source is also applicable. Descriptions of a detailed structure of the backlight unit BL are omitted. If the liquid crystal display panel PNL is in a reflective type having the reflective display function alone, the backlight unit BL is omitted.

The sensor SE comprises a plurality of detection electrodes Rx. The detection electrodes Rx are provided above, for example, an outer surface ES on a screen side on which the image of the liquid crystal display panel PNL is displayed. For this reason, the detection electrodes Rx may be in contact with the outer surface ES or may be positioned remote from the outer surface ES. In the latter case, a member such as an insulating film is provided between the outer surface ES and the detection electrodes Rx. In the present embodiment, the detection electrodes Rx are in contact with the outer surface ES. The outer surface ES is a surface opposed to a surface of the second substrate SUB2 facing the first substrate SUB1, and includes a display surface on which the image is displayed. In the example illustrated, the detection electrodes Rx are approximately extended in a first direction X and aligned in a second direction Y crossing the first direction X. The detection electrodes Rx may be extended in the second direction Y and aligned in the first direction X or may be formed in an island shape and arrayed in a matrix in the first direction X and the second direction Y. The first direction X and the second direction Y are perpendicular to each other. A third direction Z is perpendicular to each of the first direction X and the second direction Y.

The driver IC chip IC1 serving as a first driver is mounted on the first substrate SUB1 of the liquid crystal display panel PNL. The flexible wiring board FPC1 connects the liquid crystal display panel PNL with the control module CM. The flexible wiring board FPC2 connects the detection electrodes Rx of the sensor SE with the control module CM. The driver IC chip IC2 serving as a second driver is mounted on the flexible wiring board FPC2. The flexible wiring board FPC3 connects the backlight unit BL with the control module CM. The control module CM may be restated as an application processor.

The driver IC chip IC1 and the driver IC chip IC2 are connected to each other via the flexible wiring board FPC2, etc. For example, if the flexible wiring board FPC2 comprises a branch section FPCB connected onto the first substrate SUB1, the driver IC chip IC1 and the driver IC chip IC2 may be connected via the branch section FPCB and wirings on the first substrate SUB1. Alternatively, the driver IC chip IC1 and the driver IC chip IC2 may be connected to each other via the flexible wiring board FPC1 and the flexible wiring board FPC2.

The driver IC chip IC2 can supply a timing signal to inform a driving period of the sensor SE to the driver IC chip IC1. Otherwise, the driver IC chip IC1 can supply a timing signal to inform a driving period of a common electrode CE to be explained later to the driver IC chip IC2. Otherwise, the control module CM can supply a timing signal to the driver IC chip IC1 and the driver IC chip IC2. Driving of the driver IC chip IC1 can be synchronized with driving of the driver IC chip IC2 by the timing signal.

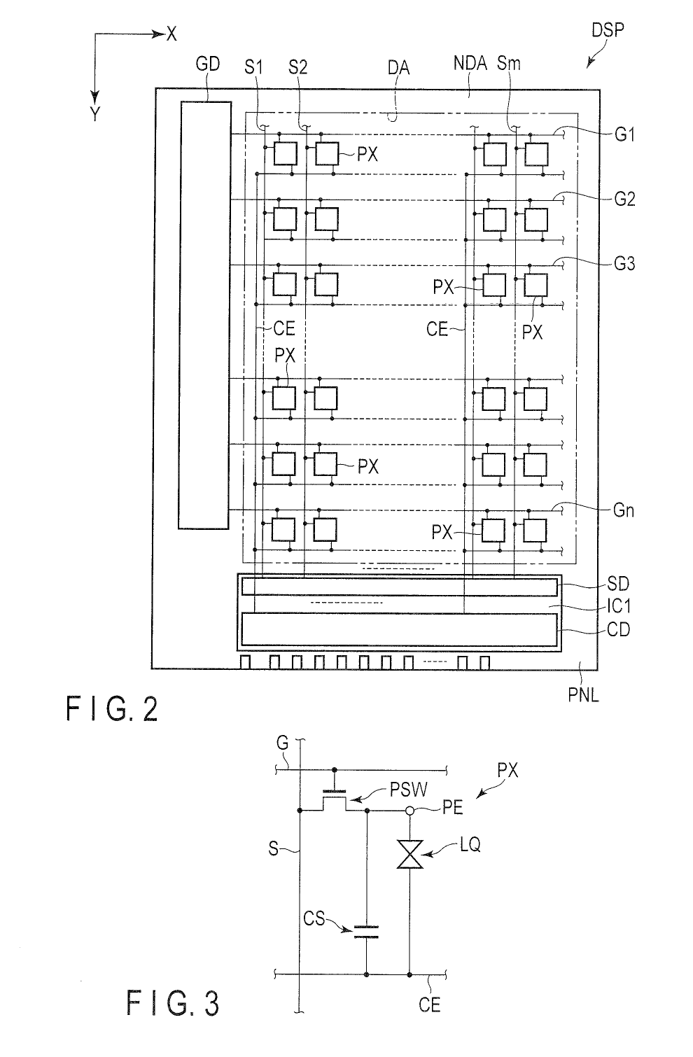

FIG. 2 is a view schematically showing a basic structure and an equivalent circuit, of the liquid crystal display device DSP shown in FIG. 1.

As shown in FIG. 2, the liquid crystal display device DSP comprises the driver IC chip IC1, a gate line driving circuit GD, etc. located in a non-display area NDA outside the display area DA, besides the liquid crystal display panel PNL, etc. In the present embodiment, the driver IC chip IC1 comprises a source line driving circuit SD and a common electrode driving circuit CD. The driver IC chip IC1 may comprise at least part of the source line driving circuit SD and the common electrode driving circuit CD. The non-display area NDA is in a frame shape (rectangular frame shape) surrounding the display area DA.

The liquid crystal display panel PNL includes a plurality of pixels PX in the display area DA. The pixels PX are arrayed in a matrix of m×n in the first direction X and the second direction Y (where m and n are positive integers). In addition, the liquid crystal display panel PNL includes number n of gate lines G (G1 to Gn), number m of source lines S (S1 to Sm), the common electrode CE, etc. in the display area DA.

The gate lines G extend substantially linearly in the first direction X, are led out to the outside of the display area DA, and are connected to the gate line driving circuit GD. In addition, the gate lines G are spaced apart and aligned in the second direction Y. The source lines S extend substantially linearly in the second direction Y, are led out to the outside of the display area DA, and are connected to the source line driving circuit SD. In addition, the source lines S are spaced apart and aligned in the first direction X, and cross the gate lines G. The gate lines G and the source lines S may not extend linearly, but may be bent in part. The common electrode CE is disposed in the display area DA, and is electrically connected to the common electrode driving circuit CD. The common electrode CE is shared by the pixels PX. Details of the common electrode CE will be described later.

FIG. 3 is an equivalent circuit diagram showing one of the pixels PX shown in FIG. 2.

As shown in FIG. 3, each pixel PX comprises a pixel switching element PSW, a pixel electrode PE, the common electrode CE, a liquid crystal layer LQ, etc. The pixel switching element PSW is formed of, for example, a thin film transistor. The pixel switching element PSW is electrically connected to the gate line G and the source line S. The pixel switching element PSW may be in a top gate type or a bottom gate type. A semiconductor layer of the pixel switching element PSW is formed of, for example, polysilicon but may be formed of amorphous silicon or an oxide semiconductor. The pixel electrode PE is electrically connected to the pixel switching element PSW. The pixel electrode PE is opposed to the common electrode CE. The common electrode CE, an insulating film and the pixel electrode PE form a storage capacitor CS.

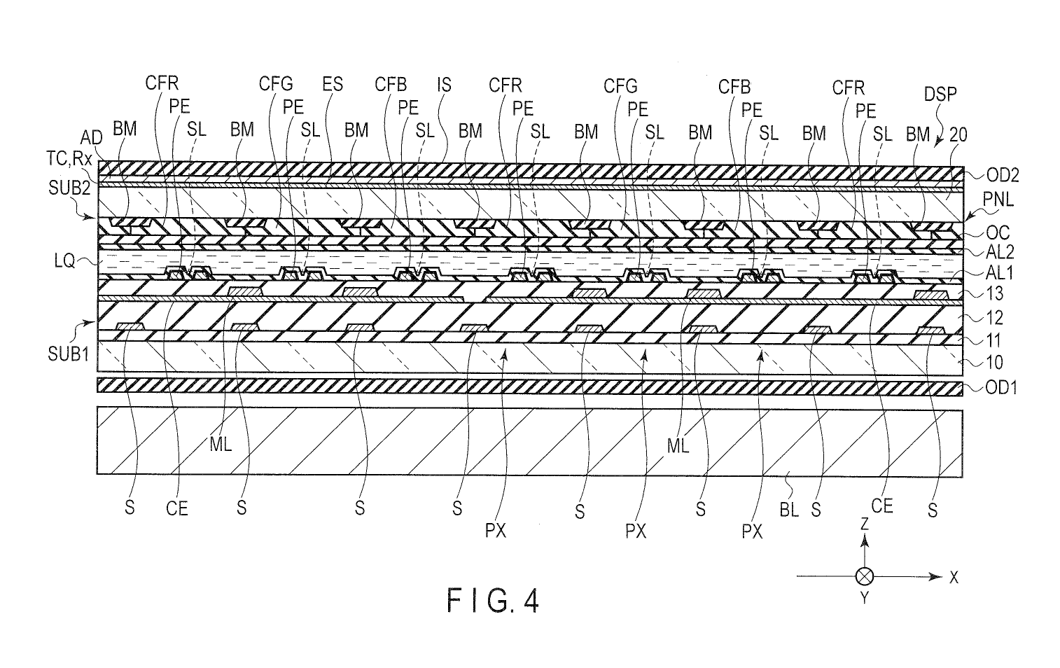

FIG. 4 is a cross-sectional view schematically showing a structure in part of the liquid crystal display device DSP.

The liquid crystal display device DSP comprises a first optical element OD1, a second optical element OD2, etc. besides the liquid crystal display panel PNL and the backlight unit BL. The liquid crystal display panel PNL shown in the drawing has a structure corresponding to fringe field switching (FFS) mode as a display mode but may have a structure correspond to the other display modes. For example, the liquid crystal display panel PNL may have a structure corresponding to an in-plane switching (IPS) mode mainly using a lateral electric field approximately parallel to a main substrate surface such as the FFS mode. In the display mode using the lateral electric field, for example, a structure comprising both the pixel electrode PE and the common electrode CE on the first substrate SUB1 can be applied. Alternatively, the liquid crystal display panel PNL may have a structure corresponding to a mode mainly using a vertical electric field approximately vertical to a main substrate surface such as twisted nematic (TN) mode, optically compensated bend (OCB) mode, and vertical aligned (VA) mode. In the display mode using the vertical electric field, for example, a structure comprising the pixel electrode PE on the first substrate SUB1 and comprising the common electrode CE on the second substrate SUB2 can be applied. The substrate main surface is a surface parallel to an X-Y plane defined by the first direction X and the second direction Y.

The liquid crystal display panel PNL comprises the first substrate SUB1, the second substrate SUB2 and the liquid crystal layer LQ. The first substrate SUB1 and the second substrate SUB2 are bonded to each other with a predetermined gap therebetween. The liquid crystal layer LQ is sealed in the gap between the first substrate SUB1 and the second substrate SUB2.

The first substrate SUB1 is formed by using a first insulating substrate 10 having a light transmitting property such as a glass substrate or a resin substrate. The first substrate SUB1 comprises source lines S, a common electrode CE, pixel electrodes PE, a first insulating film 11, a second insulating film 12, a third insulating film 13, and a first alignment film AL1, on a side of the first insulating substrate 10, which is opposed to the second substrate SUB2.

The first insulating film 11 is disposed on the first insulating substrate 10. In the present embodiment, for example, pixel switching elements of a top gate structure are applied, which is not described in detail. In such an embodiment, the first insulating film 11 includes a plurality of insulating layers laminated in a third direction Z. For example, the first insulating film 11 includes various insulating layers such as an undercoat layer formed between the first insulating substrate 10 and a semiconductor layer of the pixel switching elements, a gate insulating layer formed between the semiconductor layer and gate electrodes, and an interlayer insulating layer formed between the gate electrodes and a plurality of electrodes including source electrodes and drain electrodes. The gate lines are arranged between the gate insulating layer and the interlayer insulating layer, similarly to the gate electrodes. The source lines S are formed on the first insulating film 11. In addition, the source electrode and the drain electrode of the pixel switching element are also formed on the first insulating film 11. In the example illustrated, the source lines S extend in the second direction Y.

The second insulating film 12 is disposed on the source lines S and the first insulating film 11. The common electrode CE is formed on the second insulating film 12. Such a common electrode CE is formed of a transparent, electrically conductive material such as indium tin oxide (ITO) or indium zinc oxide (IZO). In the example illustrated, metal layers ML are formed on the common electrode CE to decrease the resistance of the common electrode CE but the metal layers ML may be omitted.

The third insulation film 13 is disposed on the common electrode CE and the second insulating film 12. The pixel electrodes PE are formed on the third insulating film 13. Each of the pixel electrodes PE is located between adjacent source lines S, and is opposed to the common electrode CE. In addition, each pixel electrode PE comprise a slit SL at a position opposed the common electrode CE. Such pixel electrodes PE are formed of, for example, a transparent, electrically conductive material such as ITO or IZO. The first alignment film AL1 covers the pixel electrodes PE and the third insulating film 13.

On the other hand, the second substrate SUB2 is formed by using a second insulating substrate 20 having a light transmitting property such as a glass substrate or a resin substrate. The second substrate SUB2 comprises a black matrix BM, color filters CFR, CFG, and CFB, an overcoat layer OC, a second alignment film AL2, etc. on a side of the second insulative substrate 20, which is opposed to the first substrate SUB1.

The black matrix BM is formed on an inner surface of the second insulating substrate 20 and partitions the respective pixels. The color filters CFR, CFG and CFB are formed on an inner surface of the second insulative substrate 20, and parts of the color filters overlap the black matrix BM. The color filter CFR is a red color filter arranged in a red pixel and is formed of a red resin material. The color filter CFG is a green color filter arranged in a green pixel and is formed of a green resin material. The color filter CFB is a blue color filter arranged in a blue pixel and is formed of a blue resin material.

In the example illustrated, the unit pixel which is a minimum unit constituting the color image is constituted by three color pixels, i.e., the red pixel, the green pixel, and the blue pixel. However, the unit pixel is not limited to a pixel formed by a combination of the three color pixels. For example, the unit pixel may be constituted by four color pixels, i.e., the red pixel, the green pixel, the blue pixel and a white pixel. In this case, a white or transparent filter may be arranged on the white pixel or the filter of the white pixel may be omitted. The overcoat layer OC covers the color filters CFR, CFG, and CFB. The overcoat layer OC is formed of a transparent resin material. The second alignment film AL2 covers the overcoat layer OC.

The second optical element OD2 is bonded on the liquid crystal display panel PNL by an adhesive layer AD. The detection electrode Rx is located between the second insulating substrate 20 and the adhesive layer AD. The detection electrode Rx is formed above a surface (outer surface ES) of the second insulating substrate 20. A detailed structure of the detection electrode Rx will be described later. In addition, illustration is simplified, and lead lines L to be described later are not shown. The detection electrode Rx is opposed to the common electrode CE through dielectric members such as the third insulating film 13, the first alignment film AL1, the liquid crystal layer LQ, the second alignment film AL2, the overcoat layer OC, the color filters CFR, CFG, and CFB, and the second insulating substrate 20.

As a material of the adhesive layer AD, for example, an acryl-based polymer may be used. The acryl-based polymer is a polymer which contains 50 wt. % or more of at least one of acrylic acid, acrylic acid salt, acrylic acid ester, methacrylic acid, methacrylic acid salt, and methacrylic acid ester.

In the present embodiment, the detection electrode Rx comprises a transparent conductive layer TC formed of, for example, ITO as the conductive material. The detection electrode Rx may comprise a transparent conductive layer formed of other transparent conductive materials such as IZO and zinc oxide (ZnO). The detection electrode Rx may be formed of a combination (aggregate) of the transparent conductive layer (TC) and metal lines (or a metal layer). This is because the time required for the detection can be shortened by lowering the electric resistance value of the detection electrode Rx. Use of metal lines or metal layer for the detection electrode Rx may be beneficial for larger size and higher fineness of the liquid crystal display panel PNL.

If a polycrystalline transparent conductive layer different from the transparent conductive layer TC of the present embodiment is used with the adhesive layer AD of the present embodiment, a risk may occur that the acrylic acid contained in the acryl-based polymer used for the adhesive layer AD is locally present at uneven portions of the transparent conductive layer. If acrylic acid is locally present at uneven portions of the transparent conductive layer, a risk may occur that the polycrystalline transparent conductive layer is corroded.

For this reason, if the transparent conductive layer TC including a plurality of crystalline regions and a plurality of amorphous regions as mentioned in the present embodiment is used, the present embodiment may be useful with respect to the point that the corrosion-resistant transparent conductive layer TC can be obtained, although described later in detail.

Incidentally, if not only the acryl-based polymer, but a material containing an acid or a material producing an acid by hydrolysis are used as the adhesive layer AD, the present embodiment may be useful.

The first optical element OD1 is disposed between the first insulating substrate 10 and the backlight unit BL. The second optical element OD2 is disposed above the detection electrode Rx. Each of the first optical element OD1 and the second optical element OD2 includes at least a polarizer and may include a retardation film as needed. An absorption axis of the polarizer included in the first optical element OD1 is orthogonal to an absorption axis of the polarizer included in the second optical element OD2. The liquid crystal display device DSP can detect position information of a portion in which a finger, etc. are in contact or in vicinity, on an input surface IS. In the present embodiment, the input surface IS of the liquid crystal display device DSP is a surface of the second optical element OD2.

However, the input surface IS is not limited to the surface of the second optical element OD2, but can be variously modified. For example, when a third insulating substrate different from the first insulating substrate 10 or the second insulating substrate 20 is located on the surface of the liquid crystal display device DSP, the input surface IS is a surface of the third insulating substrate. The third insulating substrate is a substrate having a light transmitting property such as a glass substrate or a resin substrate. If the third insulating substrate is a glass substrate, the third insulating substrate functions as a cover glass.

An example of the polarizer will be simply explained here, though described later.

The polarizer included in the second optical element OD2, etc. comprises a polarizer layer, first and second supporting layers serving as base materials provided on both surfaces of the polarizer layer, etc. The polarizer layer is formed by dyeing a polyvinyl alcohol (PVA) film with an iodine compound, uniaxially stretching the PVA film, and the like. A stretching axis serves as an absorption axis of the polarizer layer (first polarizer).

The first and second supporting layers are formed of, for example, triacetylcellulose (TAC). The first supporting layer is bonded on one of surfaces of the polarizer layer and the second supporting layer is bonded on the other surface of the polarizer layer. The first and second supporting layers protect the polarizer layer. For example, the first and second supporting layers have a moisture excluding function, and can reduce intrusion of moisture into the polarizer layer. In addition, the first and second supporting layers can reinforce the polarizer layer. The first and second supporting layers can thereby suppress shrinkage of the polarizer layer when the polarizer layer is influenced by heat or moisture.

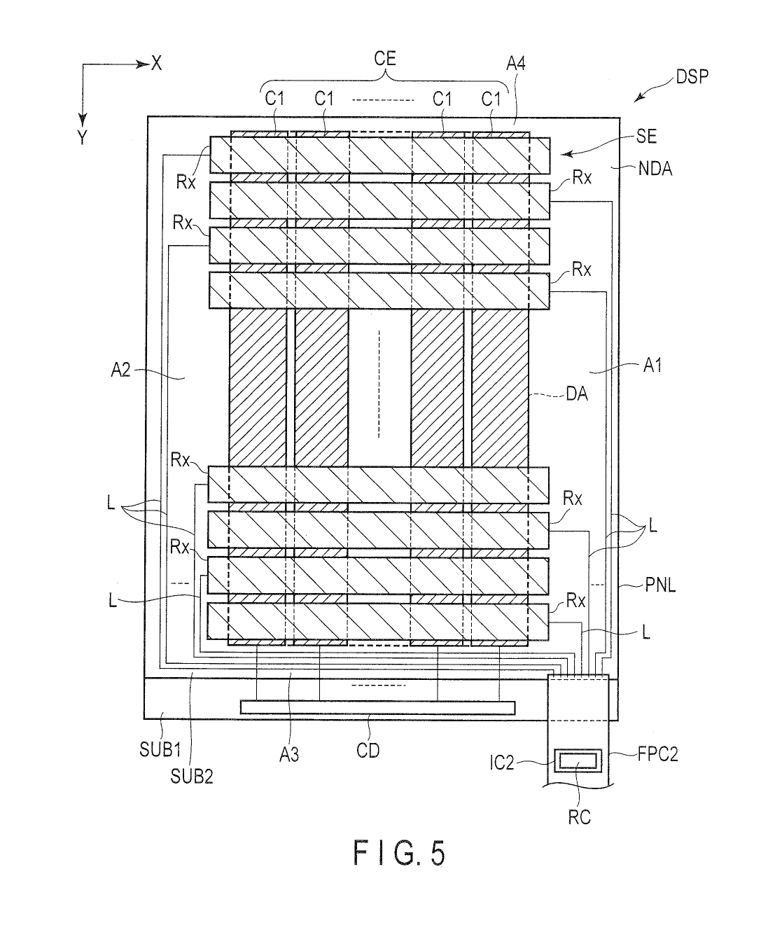

Next, the electrostatic capacitance type sensor SE of the liquid crystal display device DSP of the present embodiment will be explained. FIG. 5 is a plan view schematically showing a structure of the sensor SE in the present embodiment. In FIG. 5, the driver IC chip IC1 is not shown, but the common electrode driving circuit is provided on the driver IC chip IC1 as described above.

As shown in FIG. 5, the sensor SE of the present embodiment comprises the detection electrodes Rx and lead lines L on the second substrate SUB2 side and uses the common electrode CE on the first substrate SUB1 side. In other words, the common electrode CE functions as an electrode for display and also functions as a sensor driving electrode. The common electrode CE and the detection electrodes Rx are disposed in a display area DA. In the example illustrated, the common electrode CE comprises a plurality of divisional electrodes C1 which are spaced apart in the first direction X and are extended approximately linearly in the second direction Y, in the display area DA. Each divisional electrodes C1 is formed in a band shape.

The non-display area NDA includes a first area A1 on the right side of the second substrate SUB2 (band-shaped area extending in the second direction Y), a second area A2 on the left side of the second substrate SUB2 (band-shaped area extending in the second direction Y), a third area A3 on the lower side of the second substrate SUB2 (band-shaped area extending in the first direction X), a fourth area A4 on the upper side of the second substrate SUB2 (band-shaped area extending in the first direction X). In the present embodiment, the display area DA is in a rectangular shape.

The detection electrodes Rx are aligned and spaced apart in the second direction Y and are extended approximately linearly in the first direction X, in the display area DA. In other words, the detection electrodes Rx are extended in the direction crossing the divisional electrodes C1. The common electrode CE (divisional electrodes C1 extended in the second direction Y) and the detection electrodes Rx extended in the first direction X are opposed to each other with various dielectric members sandwiched therebetween as mentioned above.

The number, size and shape of the divisional electrodes C1 are not particularly limited and variously changed. Alternatively, the divisional electrodes C1 may be aligned and spaced apart in the second direction Y and extended approximately linearly in the first direction X, similarly to an example described later. Furthermore, the common electrode CE may not be divided and may be a single planar electrode sequentially formed in the display area DA. FIG. 5 shows the example in which the divisional electrodes C1 are extended in the second direction Y and the detection electrodes Rx are extended in the first direction X, but the electrodes are not limited to these and the divisional electrodes C1 may be extended in the first direction X and the detection electrodes Rx may be extended in the second direction Y.

The lead lines L are disposed above the outer surface ES of the liquid crystal display panel PNL, in the non-display area NDA. The lead lines L are electrically connected to the detection electrodes Rx in a one-to-one correspondence. In each of the lead lines L, sensor output values from the detection electrodes Rx are output. In the example illustrated, the lead lines L are disposed in the first area A1 and the third area A3 of the second substrate SUB2, or the second area A2 and the third area A3 of the second substrate SUB2. For example, of the lead lines L, the lead lines L connected to odd-numbered detection electrodes Rx are disposed in the second area A2 and the third area A3, and the lead lines L connected to even-numbered detection electrodes Rx are disposed in the first area A1 and the third area A3. The above-described layout of the lead lines L corresponds to the uniform width in the first direction X of the first area A1 and the second area A2, and narrow frame of the liquid crystal display device DSP.

The liquid crystal display device DSP further comprises the common electrode driving circuit (first driver) CD disposed in the non-display area NDA. Each of the divisional electrodes C1 is electrically connected to the common electrode driving circuit CD. The common electrode driving circuit CD supplies a common driving signal to the common electrode CE at a time of the display driving for displaying an image, and supplies a sensor driving signal to the common electrode CE at a time of the sensing driving for sensing.

The flexible wiring board FPC2 is connected to an outer lead bonding (OLB) pad group disposed above the outer surface ES of the liquid crystal display panel PNL, in the non-display area NDA. Pads of the OLB pad group are electrically connected to the detection electrodes Rx via the lead lines L. In the present embodiment, the lead lines L are formed of metal as a conductive material. The width of the lead lines L can be reduced by forming the lead lines L of a metal material having a much lower electrical resistance value than a transparent conductive material. Since the OLB pad group can be closely assembled at one portion in the third area A3 of the second substrate SUB2, the flexible wiring board FPC2 can be miniaturized and manufacturing costs can be reduced.

A detection circuit RC is built in, for example, the driver IC chip IC2. The detection circuit RC detects contact or close proximity of the conductor to the input surface IS of the liquid crystal display device DSP, based on the sensor output values from the detection electrodes Rx. Furthermore, the detection circuit RC can also detect position information of the portion with which the conductor is in contact or to which the conductor is in close proximity. The detection circuit RC may be disposed in the control module CM.

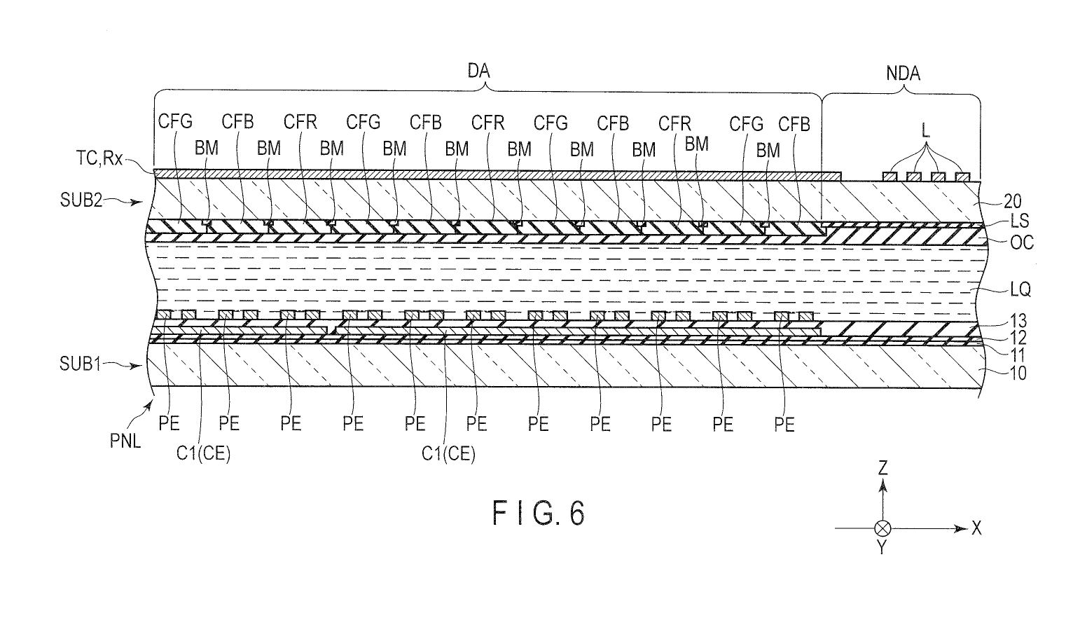

FIG. 6 is a cross-sectional view schematically showing a structure of the liquid crystal display panel PNL comprising part of the sensor SE. Main portions alone necessary for explanations are shown.

As shown in FIG. 6, the common electrode CE and the pixel electrodes PE are disposed on an inner surface side of the first substrate SUB1 which is opposed to the second substrate SUB2. In other words, the common electrode CE is formed on the second insulating film 12 and is covered with the third insulating film 13. The pixel electrodes PE are formed on the third insulating film 13 to be opposed to the common electrode CE. In the example illustrated, the pixel electrodes PE for eight pixels are disposed straight above each divisional electrode C1, but the number of the pixel electrodes PE located straight above each divisional electrode C1 is not limited to this. Various lines such as the source lines and the first alignment film are not shown.

The black matrix BM, the color filters CFR, CFG, and CFB, overcoat layer OC, and a peripheral light-shielding layer LS are located on an inner surface of the second substrate SUB2 which is opposed to the first substrate SUB1. In other words, the color filters CFR, CFG, and CFB are formed at positions opposed to the pixel electrodes PE, in the display area DA. The black matrix BM is located at each of boundaries of the color filters CFR, CFG, and CFB. The peripheral light-shielding layer LS is disposed within the non-display area NDA and is formed on the inner surface of the second insulating film 20. The peripheral light-shielding layer LS is formed in a frame shape (rectangular frame shape). The peripheral light-shielding layer LS is formed of the same material as the black matrix BM. The overcoat layer OC extends over the display area DA and the non-display area NDA. The second alignment film is not shown. The lead lines L are disposed at positions opposing the peripheral light-shielding layer LS.

The detection electrodes Rx and the lead lines L are located on the second substrate SUB2 at its external surface side which is the other side of the side opposed to the first substrate SUB1. The lead lines L are formed of a metal material such as aluminum (Al), titanium (Ti), silver (Ag), molybdenum (Mo), tungsten (W), copper (Cu) and chromium (Cr). Incidentally, the detection electrodes Rx located in the display area DA are formed of band electrodes using ITO.

Next, an operation executed at a time of the display driving for displaying an image at the above-explained FFS-mode liquid crystal display device DSP will be explained.

First, an OFF state in which no voltage is applied to the liquid crystal layer LQ will be explained. The OFF state corresponds to a state in which a potential difference is not made between the pixel electrodes PE and the common electrode CE. In such an OFF state, liquid crystal molecules included in the liquid crystal layer LQ are subjected to unidirectionally initial alignment in an X-Y plane by an alignment restriction force of the first alignment film AL1 and the second alignment film AL2. Part of backlight from the backlight unit BL passes through the polarizer of the first optical element OD1 and is made incident on the liquid crystal display panel PNL. The light incident on the liquid crystal display panel PNL is linearly polarized light orthogonal to the absorption axis of the polarizer. Such a polarized state of the linearly polarized light hardly varies when the light passes through the liquid crystal display panel PNL in the OFF state. For this reason, most part of the linearly polarized light passing through the liquid crystal display panel PNL is absorbed by the polarizer of the second optical element OD2 (black display). A mode in which the liquid crystal display panel PNL thus becomes a black display in the OFF state is called a normally black mode.

Next, an ON state in which a voltage is applied to the liquid crystal layer LQ will be explained. The ON state corresponds to a state in which a potential difference is made between the pixel electrodes PE and the common electrode CE. In other words, a common driving signal (common voltage) is supplied from the common electrode driving circuit CD to the common electrode CE. In contrast, a video signal to form a potential difference relative to the common voltage is supplied to the pixel electrodes PE. A fringing field is thereby formed between the pixel electrode PE and the common electrode CE.

In such an ON state, the liquid crystal molecules are aligned in an orientation different from the initial alignment direction in the X-Y plane. In the ON state, linearly polarized light orthogonal to the absorption axis of the polarizer of the first optical element OD1 is made incident on the liquid crystal display panel PNL, and the polarized state of the light is varied in accordance with the aligned state of the liquid crystal molecules when the light passes through the liquid crystal layer LQ. For this reason, at least part of the light passing through the liquid crystal layer LQ is transmitted through the polarizer of the second optical element OD2 (white display).

Next, an operation executed at a time of the sensing driving for sensing to detect contact or close proximity of the conductor to the input surface IS of the liquid crystal display device DSP will be explained. In other words, a sensor driving signal is supplied from the common electrode driving circuit CD to the common electrode CE. Sensing is executed by receiving a sensor signal from the common electrode CE by the sensor SE in this state.

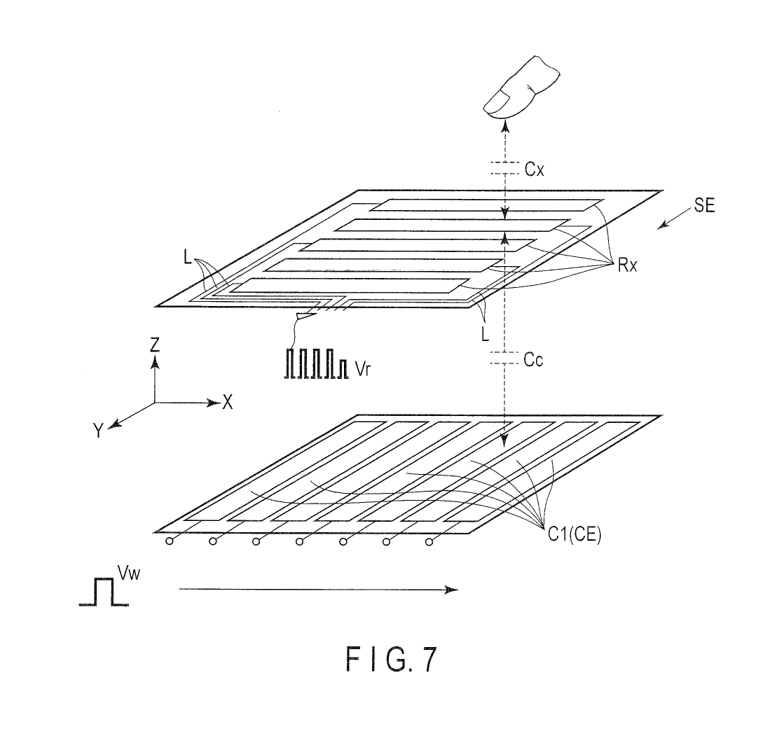

A principle in an example of a sensing method will be explained here with reference to FIG. 7.

As shown in FIG. 7, the detection electrodes Rx are disposed in at least the display area DA. Capacitance Cc is present between the divisional electrodes C1 and the detection electrodes Rx. In other words, the detection electrodes Rx are in electrostatic capacitive coupling with the divisional electrodes C1 (common electrode CE). A pulse-like write signal (sensor driving signal) Vw is supplied to each of the divisional electrodes C1, sequentially, in a predetermined cycle. In this example, it is assumed that the user's finger is present in close proximity to a position where a specific detection electrode Rx and a specific divisional electrode C1 cross. Capacitance Cx occurs due to the user's finger in close proximity to the detection electrode Rx. When the pulse-like write signal Vw is supplied to the divisional electrode C1, a pulse-like read signal (sensor output value) Vr of a level lower than levels of pulses obtained from the other detection electrodes is obtained from the specific detection electrode Rx. In other words, when input position information that is the position information of the user's finger in the display area DA is detected, the driver IC chip IC1 (common electrode driving circuit CD) serving as the first driver supplies the write signal Vw to the common electrode CE (divisional electrodes C1) and generates the sensor signal between the common electrode CE and the sensor SE. The driver IC chip IC2 serving as the second driver is connected to the sensor SE and reads the read signal Vr indicating variation of the sensor signal (for example, the electrostatic capacitance occurring at the detection electrode Rx).

The detection circuit RC in FIG. 5 can detect two-dimensional position information of the finger in the X-Y plane of the sensor SE, based on the timing of supplying the write signal Vw to the divisional electrodes C1 and on the read signal Vr from each of the detection electrodes Rx. In addition, the capacitance Cx in a case where the finger is close to the detection Rx is different from that in a case where the finger is far from the detection Rx. For this reason, the level of the read signal Vr in a case where the finger is close to the detection Rx is different from that in a case where the finger is remote from the detection Rx. The detection circuit RC therefore can also detect the proximity of the finger to the sensor SE (i.e., a distance in a normal direction of the sensor SE), based on the level of the read signal Vr.

Next, the transparent conductive layer TC of the detection electrode Rx will be explained.

The transparent conductive layer TC is formed of a transparent conductive material such as ITO, IZO and ZnO as explained above. The transparent conductive layer TC includes a plurality of first regions R1 in a crystalline state and a plurality of second regions R2 in an amorphous state. The first regions R1 and the second regions R2 are mixed. The first regions R1 and the second regions R2 are mixed in all areas of the transparent conductive layer TC including the surface and the inner side of the transparent conductive layer TC. The transparent conductive layer TC is formed by adjusting various manufacturing conditions such as a temperature.

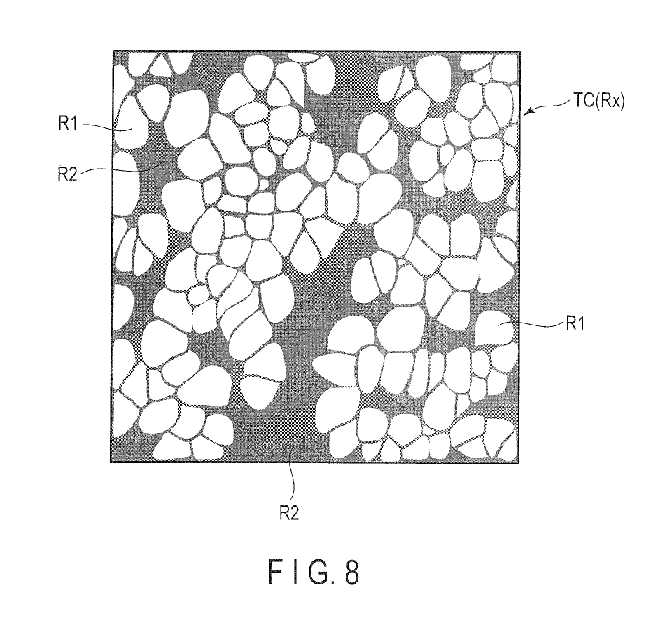

A result of using ITO to form the transparent conductive layer TC of the present embodiment and executing SEM-EBSD analysis for ITO is shown in FIG. 8. The SEM-EBSD analysis is to measure and analyze an electron backscatter diffraction (EBSD) pattern while scanning an electron beam by employing a scanning electron microscope (SEM). The EBSD pattern can be obtained by irradiating the transparent conductive layer TC with an electron beam from the SEM. In FIG. 8, the first regions R1 are presented in white and the second regions R2 are presented in gray. In the drawing, brightness of the second regions R2 is lower than brightness of the first regions R1. The second regions R2 are gray since the EBSD pattern cannot be obtained from the amorphous areas. It can be understood from FIG. 8 that the first regions R1 and the second regions R2 are mixed in the transparent conductive layer TC.

According to the sensor-equipped liquid crystal display device DSP of the first embodiment, which is constituted as mentioned above, the liquid crystal display device DSP comprises the liquid crystal display panel PNL comprising the second substrate SUB2, the first optical element OD1 (polarizer), the adhesive layer AD, and the electrostatic capacitance type sensor SE. The polarizer is located outside the liquid crystal display panel PNL and is opposed to the second substrate SUB2. The polarizer is bonded on the liquid crystal display panel PNL by the adhesive layer AD.

The sensor SE comprises the detection electrodes Rx. Each of the detection electrodes Rx is located between the second substrate SUB2 and the adhesive layer AD, and comprises the transparent conductive layer TC formed of a transparent conductive material. The transparent conductive layer TC includes the first regions R1 in a crystalline state and the second regions R2 in an amorphous state, which are mixed together.

The transparent conductive layer TC having a low electric resistance and a great resistance to corrosion can be formed by the amorphous transparent conductive layer.

The transparent conductive layer TC of the present embodiment is not formed to be much hard, unlike a polycrystalline transparent conductive layer. For this reason, stress applied to the transparent conductive layer TC can be dispersed inside the transparent conductive layer TC. Thus, fracture (crash) and corrosion can hardly occur on the transparent conductive layer TC. Examples of the stress applied to the transparent conductive layer TC includes stress generated by shrinkage of the polarizer and stress generated when the liquid crystal display device DSP is manufactured. The stress generated at the manufacturing is stress generated when, for example, a mother substrate (second substrate SUB2) on which the detection electrodes Rx are formed is conveyed. The mother substrate is an original substrate of the second substrate SUB2.

Furthermore, the unevenness on the surface of the transparent conductive layer TC of the present embodiment does not become great, unlike a polycrystalline transparent conductive layer. The uneven portions in which ionic components included in the adhesive layer AD for the polarizer are easily located can hardly be formed on the transparent conductive layer TC. Corrosion of the transparent conductive layer TC resulting from the ionic components can be thereby suppressed.

The sensor-equipped liquid crystal display device DSP having a high manufacturing yield can be therefore obtained. Alternatively, the sensor-equipped liquid crystal display device DSP having a high product yield can be obtained.

### Second Embodiment

Next, a sensor-equipped liquid crystal display device DSP of a second embodiment will be described in detail. The liquid crystal display device DSP of the present embodiment is formed in the same manner as the liquid crystal display device DSP of the First Embodiment except a transparent conductive layer TC. In the present embodiment, a rate of area of first regions R1 to the transparent conductive layer TC will be explained.

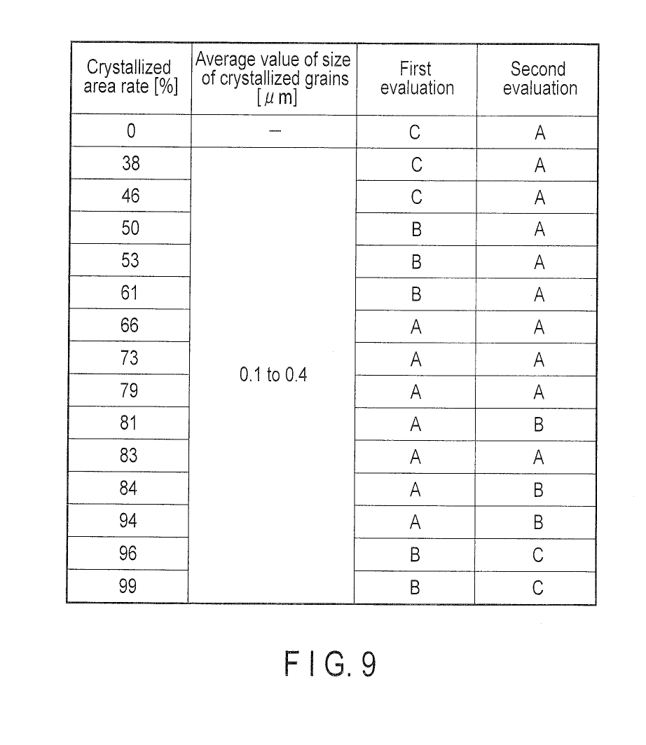

The present inventors varied a crystallization area rate of the transparent conductive layer TC and researched a reliability test and a state of the transparent conductive layer TC. The crystallization area rate indicates a rate of area of a crystallized region per unit area in the transparent conductive layer TC. In the present embodiment, a PCT test is employed as the reliability test. In the PCT test of the present embodiment, the liquid crystal display device DSP was left for 20 hours in an environment of 120° C., 95% RH and 2 atmospheric pressures. FIG. 9 shows a first evaluation based on the reliability test and a second evaluation on the state of the transparent conductive layer TC. FIG. 9 is a table showing (1) an average value of a size of crystallized grains in the transparent conductive layer TC, (2) the first evaluation based on the reliability test, and (3) the second evaluation on the state of the transparent conductive layer TC, obtained when the crystallization area rate is varied. The second evaluation is an evaluation on a degree of inconvenience as to whether the fracture (break), etc. occurred on the transparent conductive layer TC or not.

As shown in FIG. 9, fifteen samples of the liquid crystal display device DSP having the crystallization area rate of 0%, 38%, 46%, 50%, 53%, 61%, 66%, 73%, 79%, 81%, 83%, 84%, 94%, 96% and 99% were prepared. When the crystallization area rate was 0%, the entire area of the transparent conductive layer TC was amorphous. When the crystallization area rate was in a range from 38 to 99%, the average value of the size of the crystallized grains in the transparent conductive layer TC was in a range from 0.1 to 0.4 μm. The crystallized grains correspond to the first regions R1.

In the first evaluation, symbol A indicates a case where corrosion or rise in the resistance value did not occur in the transparent conductive layer TC, symbol B indicates a case where corrosion did not occur in the transparent conductive layer TC but the resistance value of the transparent conductive layer TC rose, and symbol C indicates a case where corrosion occurred in the transparent conductive layer TC.

In the second evaluation, symbol A indicates a case where fracture (break) or dissolution did not occur in the transparent conductive layer TC, symbol B indicates a case where fracture did not occur in the transparent conductive layer TC but the dissolution occurred in the transparent conductive layer TC, which caused the resistance value of the transparent conductive layer TC to rise, and symbol C indicates a case where fracture occurred in the transparent conductive layer TC.

As understood from FIG. 9, when the crystallization area rate is in a range from 50 to 94%, the first evaluation and the second evaluation are A or B. For this reason, the transparent conductive layer TC may desirably be formed to set the crystallization area rate to be in a range from 50 to 94%. Furthermore, when the crystallization area rate is in a range from 66 to 79%, the first evaluation and the second evaluation are A alone. For this reason, the transparent conductive layer TC may desirably be formed to set the crystallization area rate to be in a range from 66 to 79%.

According to the sensor-equipped liquid crystal display device DSP of the Second Embodiment constituted as mentioned above, the liquid crystal display device DSP comprises a liquid crystal display panel PNL, a polarizer, an adhesive layer AD, and an electrostatic capacitance type sensor SE. The transparent conductive layer TC includes a plurality of first regions R1 and a plurality of second regions R2, which are mixed together. For this reason, the same advantage as that obtained in the First Embodiment can also be obtained in the present embodiment.

The first regions R1 may desirably occupy 50 to 94% of the transparent conductive layer TC (detection electrodes Rx). The first regions R1 may, more desirably, occupy 66 to 79% of the transparent conductive layer TC (detection electrodes Rx).

The sensor-equipped liquid crystal display device DSP having a higher manufacturing yield than the First Embodiment can be thereby obtained. Alternatively, the sensor-equipped liquid crystal display device DSP having a higher product yield than the First Embodiment can be obtained.

### Third Embodiment

Next, a sensor-equipped liquid crystal display device DSP of a third embodiment will be described in detail. The liquid crystal display device DSP of the present embodiment is formed in the same manner as the liquid crystal display device DSP of the First Embodiment except a transparent conductive layer TC. In the present embodiment, an average value of a size of crystallized grains in the transparent conductive layer TC will be explained.

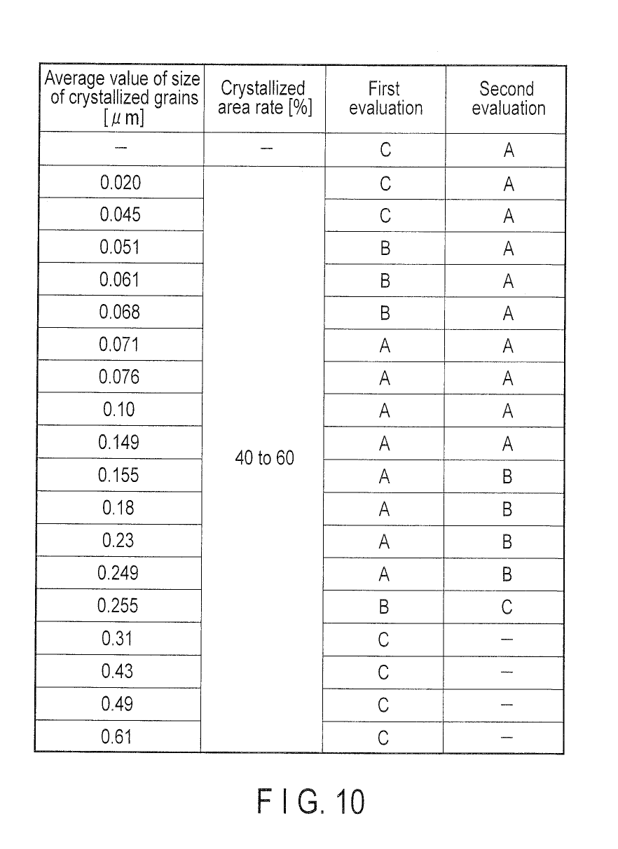

The present inventors varied the average value of the size of crystallized grains in the transparent conductive layer TC and researched a reliability test and a state of the transparent conductive layer TC. The reliability test was a twenty-hour PCT test. FIG. 10 shows a first evaluation based on the reliability test and a second evaluation on the state of the transparent conductive layer TC. FIG. 10 is a table showing (1) a crystallization area rate in the transparent conductive layer TC, (2) the first evaluation based on the reliability test, and (3) the second evaluation on the state of the transparent conductive layer TC, obtained when the average value of the size of crystallized grains in the transparent conductive layer TC was varied. The second evaluation is an evaluation on a degree of inconvenience as to whether fracture (break), etc. occurred on the transparent conductive layer TC or not.

As shown in FIG. 10, nineteen samples of the liquid crystal display device DSP having the average value of the size of crystallized grains in the transparent conductive layer TC of “—” (no crystallized grains), 0.020 μm, 0.045 μm, 0.051 μm, 0.061 μm, 0.068 μm, 0.071 μm, 0.076 μm, 0.10 μm, 0.149 μm, 0.155 μm, 0.18 μm, 0.23 μm, 0.249 μm, 0.255 μm, 0.31 μm, 0.43 μm, 0.49 μm, and 0.61 μm were prepared. When the average value of the size of crystallized grains in the transparent conductive layer TC was in a range from 0.020 to 0.61 μm, the crystallization area rate was in a range from 40 to 60%. The crystallized grains correspond to the first regions R1, too.

In the first evaluation, symbol A indicates a case where corrosion or rise in the resistance value did not occur in the transparent conductive layer TC, symbol B indicates a case where corrosion did not occur in the transparent conductive layer TC but the resistance value of the transparent conductive layer TC rose, and symbol C indicates a case where corrosion occurred in the transparent conductive layer TC.

In the second evaluation, symbol A indicates a case where fracture (break) or dissolution did not occur in the transparent conductive layer TC, symbol B indicates a case where fracture did not occur in the transparent conductive layer TC but the dissolution occurred in the transparent conductive layer TC, which caused the resistance value of the transparent conductive layer TC to rise, and symbol C indicates a case where fracture occurred in the transparent conductive layer TC.

As understood from FIG. 10, when the average value of the size of crystallized grains in the transparent conductive layer TC is in a range from 0.051 to 0.249 μm, the first evaluation and the second evaluation are A or B. For this reason, the transparent conductive layer TC may desirably be formed to set the average value of the size of crystallized grains in the transparent conductive layer TC to be in a range from 0.05 to 0.25 μm. Furthermore, when the average value of the size of crystallized grains in the transparent conductive layer TC is in a range from 0.071 to 0.149 μm, the first evaluation and the second evaluation are A alone. For this reason, the transparent conductive layer TC may desirably be formed to set the average value of the size of crystallized grains in the transparent conductive layer TC to be in a range from 0.07 to 0.15 μm.

According to the sensor-equipped liquid crystal display device DSP of the Third Embodiment constituted as mentioned above, the liquid crystal display device DSP comprises a liquid crystal display panel PNL, a polarizer, an adhesive layer AD, and an electrostatic capacitance type sensor SE. The transparent conductive layer TC includes a plurality of first regions R1 and a plurality of second regions R2, which are mixed together. For this reason, the same advantage as that obtained in the First Embodiment can also be obtained in the present embodiment.

The average value of the size in the first regions R1 may desirably be 0.05 to 0.25 μm. The average value of the size in the first regions R1 may, more desirably, be 0.07 to 0.15 μm. The sensor-equipped liquid crystal display device DSP having a higher manufacturing yield than the First Embodiment can be thereby obtained. Alternatively, the sensor-equipped liquid crystal display device DSP having a higher product yield than the First Embodiment can be obtained.

### Fourth Embodiment

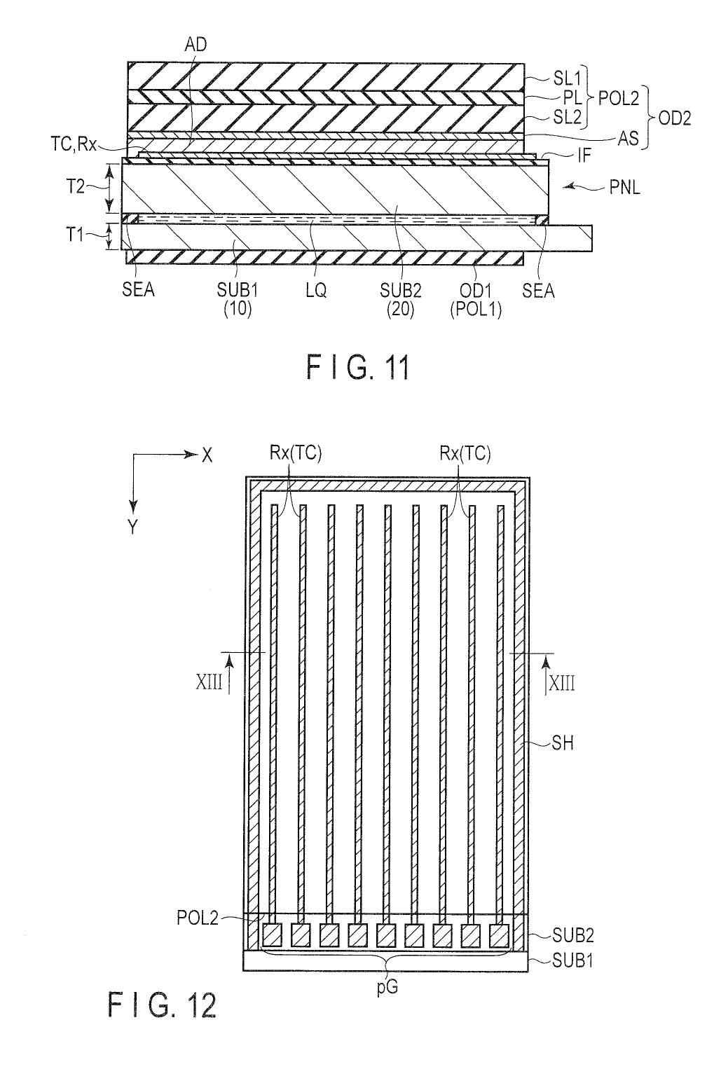

Next, a sensor-equipped liquid crystal display device DSP of a forth embodiment will be described in detail. The liquid crystal display device DSP of the present embodiment is formed in the same manner as the liquid crystal display device DSP of the First Embodiment except a polarizer of a second optical element OD2, an adhesive layer AD, a first insulating substrate 10, and a second insulating substrate 20. FIG. 11 is a cross-sectional view schematically showing a structure of the sensor-equipped liquid crystal display device DSP of the present embodiment.

As shown in FIG. 11, the first optical element OD1 comprises at least a polarizer POL1. The second optical element OD2 comprises a polarizer POL2 and an antistatic layer AS. The polarizer POL2 comprises a polarizer layer PL, a first supporting layer SL1 and a second supporting layer SL2. The second supporting layer SL2 is located between a second substrate SUB2 and the first supporting layer SL1. The polarizer layer PL is located between the first supporting layer SL1 and the second supporting layer SL2.

In the present embodiment, the first supporting layer SL1 is formed of TAC. The second supporting layer SL2 has a lower moisture permeability than that of the first supporting layer SL1. In addition, the second supporting layer SL2 generates a smaller amount of acid than an amount of acid generated by the first supporting layer SL1. The second supporting layer SL2 is formed of, for example, a cyclic olefin structure polymer. The polarizer layer PL is formed by dyeing a polyvinyl alcohol (PVA) film with an iodine compound, uniaxially stretching the PVA film, and the like. A stretching axis serves as an absorption axis of the polarizer layer PL (polarizer POL2).

The first supporting layer SL1 and the second supporting layer SL2 are bonded on the polarizer layer PL. The first supporting layer SL1 and the second supporting layer SL2 protect the polarizer layer PL. The first supporting layer SL1 and the second supporting layer SL2 can suppress shrinkage of the polarizer layer when the polarizer layer PL is influenced by heat or moisture. Since TAC and PVA have good adhesive property, the first supporting layer SL1 can particularly hold the polarizer layer PL and reinforce the polarizer layer PL.

In addition, the first supporting layer SL1 and the second supporting layer SL2 have a moisture excluding function, and can reduce intrusion of moisture into the polarizer layer PL. Since the second supporting layer SL2 particularly has a lower moisture permeability than that of the first supporting layer SL1, the second supporting layer SL2 can further reduce intrusion of moisture from the outside than the first supporting layer SL1.

Furthermore, TAC (first supporting layer SL1) generates acid (acetic acid) by hydrolysis, but the cyclic olefin structure polymer (second supporting layer SL2) does not generate acid (acetic acid) by hydrolysis. At least the amount of acid generated by the cyclic olefin structure polymer (second supporting layer SL2) is smaller than the amount of acid generated by TAC (first supporting layer SL1).

The antistatic layer AS is disposed between a detection electrode Rx and the polarizer POL2. The antistatic layer AS is disposed on a surface of the second supporting layer SL2, which is opposed to the liquid crystal display panel PNL. The antistatic layer AS is formed of an organic material or an inorganic material. The antistatic layer AS is formed of an organic material here. The antistatic layer AS has a sheet resistance in a range from 10⁹ to 10¹¹ Ω/□. The antistatic layer AS aims to prevent the polarizer POL2 from being charged.

The antistatic layer AS can prevent static electricity from the outside from being directly applied to the transparent conductive layer TC and can protect the comparatively soft transparent conductive layer TC. The antistatic layer AS can prevent destruction of the transparent conductive layer TC. In addition, the antistatic layer AS can dissipate electric charges stored in the antistatic layer AS to the outside via the detection electrode Rx (transparent conductive layer TC).

Incidentally, the antistatic layer AS may be disposed as needed. For example, if the liquid crystal display device is DSP is formed without the antistatic layer AS, the adhesive layer AD may function as an antistatic layer. In this case, the adhesive layer AD may have a sheet resistance in a range from 10⁹ to 10¹¹ Ω/□.

An insulating film IF is disposed between the second insulating substrate 20 (second substrate SUB2) and the transparent conductive layer TC. In the present embodiment, the insulating film IF is formed by laminating an insulating film formed of silicon dioxide (SiO₂) and an insulating film formed of niobium pentoxide (Nb₂O₅). A material for formation of the insulating film IF can be variously modified. For example, the insulating film IF may be formed of an insulating film of SiO₂ alone.

The transparent conductive layer TC is not formed directly on the second insulating substrate 20, but on the insulating film IF. Close contact between the transparent conductive layer TC and the insulating film IF is stronger than close contact between the transparent conductive layer TC and the second insulating substrate 20. For this reason, the transparent conductive layer TC having an excellent property of close contact can be formed and the transparent conductive layer TC in which fracture (break) hardly occurs can be formed. In addition, corrosion of the transparent conductive layer TC can be suppressed since the transparent conductive layer TC is not formed directly on the second insulating substrate 20. Incidentally, when the second insulating substrate 20 is subjected to chemical polishing, fluorine used for the chemical polishing may easily remain on the second insulating substrate 20 and fluorine may react with ITO. Corrosion of the transparent conductive layer TC may be thereby caused as explained above.

Furthermore, protrusions and depressions may be formed on the surface of the insulating film IF. By forming the transparent conductive layer TC on the insulating film IF, a number of nuclei can be formed at the crystallization, and the transparent conductive layer TC including the locally crystallized region (first region R1) can easily be formed.

In the present embodiment, a refractive index of the insulating film IF is adjusted to be between a refractive index of the second insulating substrate 20 and a refractive index of the transparent conductive layer TC. By allowing the insulating film IF to function as what is called an index matching layer, interface reflection on the insulating film IF can be suppressed.

Technology for suppressing the dissolution of the ITO (transparent conductive layer TC) caused by acid will be explained here.

The TAC (first supporting layer SL1) generates acetic acid as explained above. In addition, iodine contained in the PVA (polarizer layer PL) can be iodic acid. Acids such as acetic acid and iodic acid cause dissolution of the ITO (transparent conductive layer TC). In the present embodiment, however, the second supporting layer SL2, the antistatic layer AS, and the adhesive layer AD are disposed between members containing the first supporting layer SL1 and the polarizer layer PL, and the transparent conductive layer TC. Since the first supporting layer SL1 and the polarizer layer PL are located remote from the transparent conductive layer TC, the acids (acetic acid and iodic acid) can be made to hardly reach the transparent conductive layer TC.

In addition, the adhesive layer AD contains at least an acid (acrylic acid), but the adhesive layer AD of the present embodiment is weaker in acidity than an adhesive layer in a polarizer of a general liquid crystal display device. In this case, for example, the adhesive layer AD for the polarizer POL2 can be weaker in acidity than the adhesive layer for the polarizer POL1. However, it should be noted that the polarizer POL2 may easily be peeled off if the acidity of the adhesive layer AD is too weak.

Considering the above, the dissolution of the transparent conductive layer TC caused by the acids (acetic acid, iodic acid and acrylic acid) can be therefore suppressed.

Next, the liquid crystal display panel PNL of the present embodiment will be explained.

The liquid crystal display panel PNL comprises a sealing member SEA. The sealing member SEA is disposed in the non-display area NDA and is formed in a rectangular frame shape. The first substrate SUB1 and the second substrate SUB2 are bonded by the sealing member SEA. For this reason, the liquid crystal layer LQ is formed in a space surrounded by the first substrate SUB1, the second substrate SUB2 and the sealing member SEA.

A thickness T2 of the second insulating substrate 20 is greater than a thickness T1 of the first insulating substrate 10. This is because, when the total thickness of the first insulating substrate 10 and the second insulating substrate 20 is fixed, the insulating substrates are hardly bent by making the thickness of one of the insulating substrates greater than the thickness of the other insulating substrate, rather than making the thickness of first insulating substrate 10 and the thickness of the second insulating substrate 20 equal to each other. For this reason, the thickness T1 may be greater than the thickness T2 as a modified example and, in this case, too, the insulating substrates can be made to be hardly bent.

However, T1 is preferably smaller than T2. This is because a time constant of the transparent conductive layer TC can be made smaller as a distance from the transparent conductive layer TC (detection electrode Rx) to the common electrode CE can be made longer.

According to the sensor-equipped liquid crystal display device DSP of the Fourth Embodiment constituted as mentioned above, the liquid crystal display device DSP comprises a liquid crystal display panel PNL, a polarizer, an adhesive layer AD, and an electrostatic capacitance type sensor SE. The transparent conductive layer TC includes a plurality of first regions R1 and a plurality of second regions R2, which are mixed together. For this reason, the same advantage as that obtained in the First Embodiment can also be obtained in the present embodiment.

The sensor-equipped liquid crystal display device DSP having a high manufacturing yield can be therefore obtained. Alternatively, the sensor-equipped liquid crystal display device DSP having a high product yield can be obtained.

### Fifth Embodiment

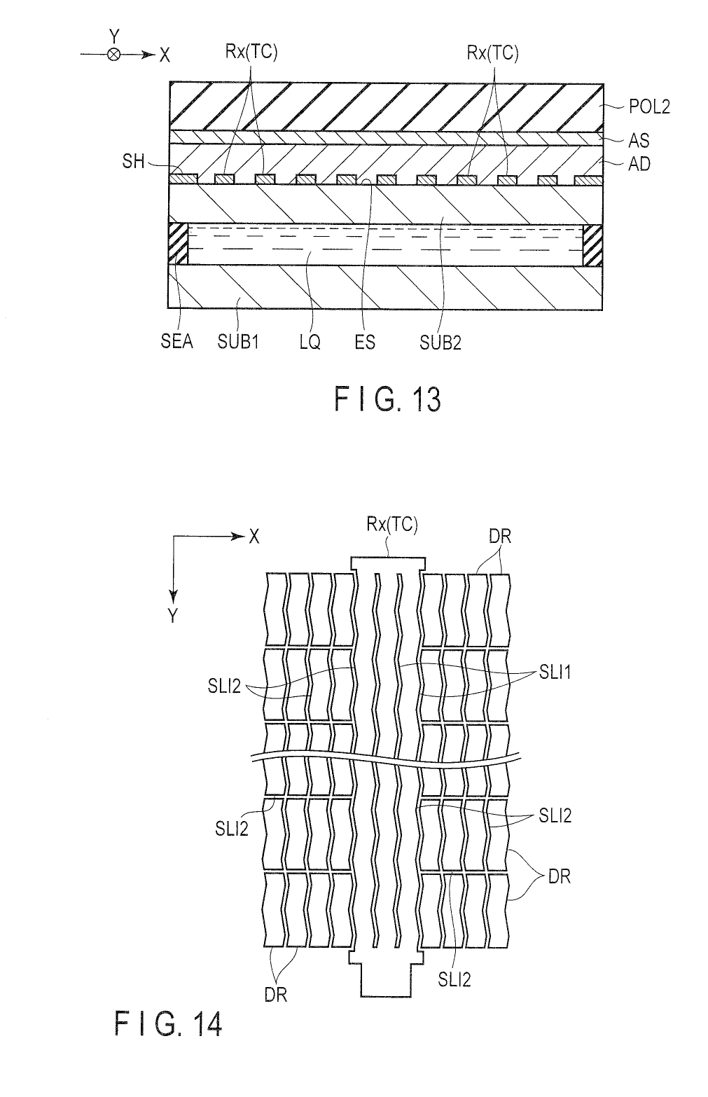

Next, a sensor-equipped liquid crystal display device DSP of a fifth embodiment will be described in detail. In the present embodiment, the same elements as those in the First Embodiment are denoted by like or similar reference numerals and detailed explanations are omitted. FIG. 12 is a schematic plan view showing in part the sensor-equipped liquid crystal display device of the present embodiment, and illustrating detection electrodes, a shielding electrode and an OLB pad group. FIG. 13 is a schematic cross-sectional view showing the liquid crystal display device as seen along line XIII-XIII in FIG. 12. FIG. 14 is an enlarged plan view showing in part the sensor-equipped liquid crystal display device shown in FIG. 12 and illustrating a detection electrode Rx and dummy electrodes DR.

As shown in FIG. 12 and FIG. 13, the dummy electrodes DR, the shielding electrode SH and the OLB pad group pG are formed besides detection electrodes Rx, above an outer surface ES of a second substrate SUB2. The detection electrode Rx includes a transparent conductive layer TC. In the present embodiment, the transparent conductive layer TC, the dummy electrodes DR, the shielding electrode SH and the OLB pad group pG are formed of ITO, on the same layer.

The transparent conductive layers TC and the OLB pad group pG are electrically connected to each other. The OLB pad group pG is located in a non-display area NDA and is connected to a flexible wiring board FPC2. The OLB pad group pG include pads configured to read read signals (sensor output values) Vr from the transparent conductive layers TC (detection electrodes Rx).

As shown in FIG. 12 to FIG. 14, the transparent conductive layers TC extend approximately in a second direction Y. The transparent conductive layers TC are spaced apart and aligned in a first direction X. A plurality of divisional electrodes (C1) in a common electrode CE extend approximately in the first direction X, and are spaced apart and aligned in the second direction Y. Alternatively, the common electrode CE is not divided but is formed as a single flat electrode sequentially formed in a display area DA. In the example illustrated, the transparent conductive layers TC are formed in a wave shape (more specifically, a triangular wave shape). The transparent conductive layers TC are formed in a zigzag pattern. Each transparent conductive layer TC includes inclined portions which obliquely cross the second direction Y.

A polarizer POL2 includes an edge parallel to the second direction Y in which the transparent conductive layers TC extend, and an edge parallel to the first direction X. An absorption axis of the polarizer POL2 is parallel to the first direction X. The inclined potions are inclined to an outer shape of the polarizer POL2. Since the transparent conductive layer TC includes the inclined portions, stress acting on the transparent conductive layer TC can be diffused by shrinkage of the polarizer POL2 (polarizer layer PL). For example, even if the polarizer POL2 shrinks due to high temperature, high moisture, etc., the transparent conductive layer TC can diffuse the stress. For this reason, the transparent conductive layer TC can hardly be cracked.

In addition, the transparent conductive layer TC includes a plurality of slits SLI1 that approximately extend in the second direction Y. The slits SLI1 are formed of a plurality of inclined portions that are inclined in a direction in a range of ±45° to a direction along the transmitting axis (second direction Y) of the polarizer POL2. Since the transparent conductive layer TC includes the slits SLI1 as explained above, stress acting on the transparent conductive layer TC can be diffused by shrinkage of the polarizer POL2 (polarizer layer PL).

Each dummy electrode DR that is the transparent electrode is disposed between adjacent transparent conductive layers TC (detection electrodes Rx). The dummy electrode DR is also formed in a wave shape (more specifically, a triangular wave shape). The transparent conductive layers TC and the dummy electrodes DR are electrically insulated from each other, and the dummy electrodes DR are also electrically insulated from each other. The dummy electrodes DR are electrically in a floating state. A plurality of slits SLI2 are formed between the transparent conductive layers TC and the dummy electrodes DR, and between the dummy electrodes DR.

Of the slits SLI1 and SLI2 formed by the transparent conductive layers TC and the dummy electrodes DR, the most slits are inclined in a direction in a range of ±45° to a direction along the transmitting axis of the polarizer POL2. In other words, of the slits SLI1 and SLI2, most components are approximately orthogonal to the stretching axis of the polarizer POL2. For this reason, the polarizer POL2 (polarizer layer PL) can hardly be shrank.

As shown in FIG. 12 and FIG. 13, the shielding electrode SH is disposed in the non-display area NDA. The shielding electrode SH is located between the second insulating substrate 20 and the polarizer POL2. In FIG. 12, the shielding electrode SH is formed into the shape of Π and continuously formed from the left side portion to the upper side portion and the right side portion of the second substrate SUB2. The shielding electrode SH is connected to the flexible wiring board FPC2, similarly to the OLB pad group pG, and voltage is applied to the shielding electrode SH through the flexible wiring board FPC2. The shielding electrode SH shields an electric field which is generated by the detection electrodes RX and which may influence a peripheral portion of the liquid crystal display panel PNL. For example, the shielding electrode SH can shield the electric field which may become noise to the gate line driving circuit GD (FIG. 2). Since the shielding electrode SH guards the TFT which forms the gate line driving circuit GD, the shielding electrode SH also serves as a guard electrode.

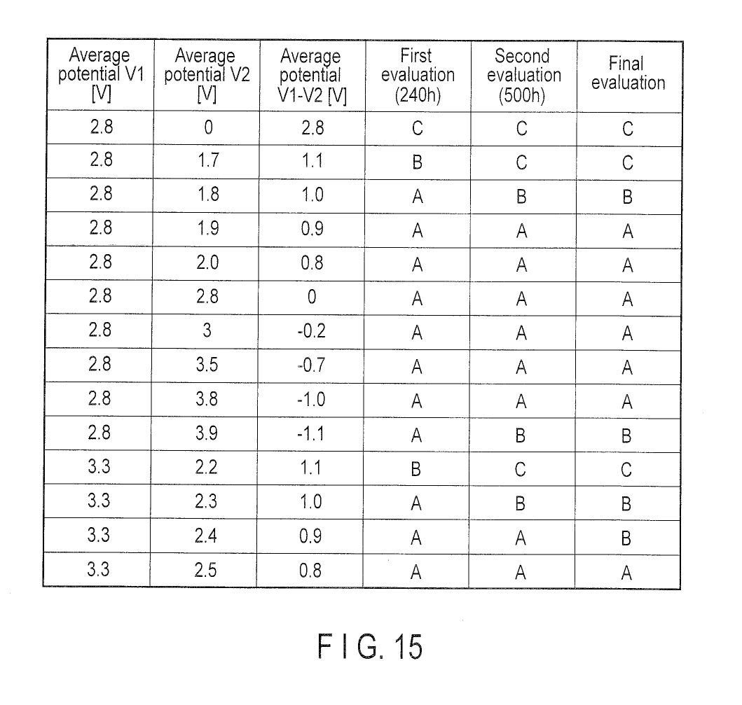

The present inventors varied an average potential of the transparent conductive layers TC (detection electrodes Rx) and an average potential of the shielding electrode SH, executed a high-temperature continuous energization test, and evaluated resistance of the transparent conductive layers TC to the operation state at a high temperature for a long time. FIG. 15 shows a first evaluation made when the test was executed for 240 hours, a second evaluation made when the test was executed for 500 hours, and a final evaluation which is a result of quality standard judgment of the transparent conductive layers TC. FIG. 15 is a table showing (1) difference V1−V2 between average potential V1 and average potential V2, (2) the first evaluation, (3) the second evaluation, and (4) the final evaluation, obtained when the average potential V1 of the detection electrodes Rx (transparent conductive layers TC) and the average potential V2 of the shielding electrode SH were varied under a temperature conduction of 70° C.

As shown in FIG. 15, ten samples of the liquid crystal display device DSP having the average potential V1 fixed at 2.8V and having the average potential V2 set at 0V, 1.7V, 1.8V, 1.9V, 2.0V, 2.8V, 3.0V, 3.5V, 3.8V, and 3.9V were prepared. Furthermore, four samples of the liquid crystal display device DSP having the average potential V1 fixed at 3.3V and having the average potential V2 set at 2.2V, 2.3V, 2.4V, and 2.5V were prepared.

In the first and second evaluations, symbol A indicates a case where the transparent conductive layers TC were unable to be visibly recognized, symbol B indicates a case where the transparent conductive layers TC were able to be visibly recognized by some persons, and symbol C indicates a case where the transparent conductive layers TC were able to be visibly recognized by a number of persons. It can be understood that the transparent conductive layers TC evaluated by symbol A were hardly discolored. It can be understood that the transparent conductive layers TC evaluated by symbol B were slightly discolored. It can be understood that the transparent conductive layers TC evaluated by symbol C were remarkably discolored.

In the final evaluation, symbol A indicates a case where the transparent conductive layers TC were hardly deteriorated and the deterioration degree was below the reference value, symbol B indicates a case where the transparent conductive layers TC were deteriorated but the deterioration degree was below the reference value, and symbol C indicates a case where the transparent conductive layers TC were deteriorated and the deterioration degree was over the reference value. A value below the reference value indicates that a rate of rise in the resistance value of the transparent conductive layers TC is 50% or lower.

As understood from FIG. 15, the first evaluation shows symbol A for the potential difference V1−V2 in a range from −1.1 to 1.0V, and symbol A or B for the potential difference V1−V2 in a range from −1.1 to 1.1V. The second evaluation shows symbol A for the potential difference V1−V2 in a range from −1.0 to 0.9V, and symbol A or B for the potential difference V1−V2 in a range from −1.1 to 1.0V. Furthermore, the final evaluation shows symbol A for the potential difference V1−V2 in a range from −1.0 to 0.9V, and symbol A or B for the potential difference V1−V2 in a range from −1.1 to 1.0V.

For this reason, the potential difference V1−V2 may preferably be in a range from −1.1 to +1.0V. Furthermore, the potential difference V1−V2 may, more preferably, be in a range from −1.0 to +0.8V. Deterioration of the transparent conductive layers TC can be thereby suppressed.

Since the transparent conductive layers TC are formed of microcrystalline ITO in which the first regions R1 and the second regions R2 are mixed, the transparent conductive layers TC are hardly deteriorated as compared with amorphous ITO.

Besides the above, if the potential difference V1−V2 is set to be smaller, parasitic capacitance between the transparent conductive layers TC (detection electrodes Rx) and the shielding electrode SH can be made smaller.

According to the sensor-equipped liquid crystal display device DSP of the Fifth Embodiment constituted as mentioned above, the liquid crystal display device DSP comprises a liquid crystal display panel PNL, a polarizer, an adhesive layer AD, and an electrostatic capacitance type sensor SE. The transparent conductive layer TC includes a plurality of first regions R1 and a plurality of second regions R2, which are mixed together. For this reason, the same advantage as that obtained in the First Embodiment can also be obtained in the present embodiment.

The sensor-equipped liquid crystal display device DSP having a high manufacturing yield can be therefore obtained. Alternatively, the sensor-equipped liquid crystal display device DSP having a high product yield can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiment described herein may be made without departing from the spirit of the invention. The accompanying claims and their equivalents are intended to cover such forms or modifications as would fall within the scope and spirit of the inventions.

The above-described first driver is not limited to the driver IC chip IC1 but can be variously modified, and any driver configured to supply the write signal to the common electrode CE and to generate a sensor signal between the common electrode CE and the sensor SE may be employed as the first driver. In contrast, the above-described second driver is not limited to the driver IC chip IC2 but can be variously modified, and any driver connected to the sensor SE and configured to read the read signal indicating variation in the sensor signal may be employed as the second driver.

The liquid crystal display device is disclosed as an example of the display device, in the above-described embodiments. However, the embodiments can be applied to all flat panel type display devices such as organic electroluminescent (EL) display devices, other spontaneous light emitting display devices, and electronic paper type display devices comprising electrophoretic elements, etc. In addition, it is needless to say that the above-described embodiments can be applied to not only middle and small display devices, but large display devices without specific limitation.

The following relate to aspects of the disclosure.

[C1] relates to a sensor-equipped display device, comprising:
a display panel comprising at least a substrate; and
a sensor comprising a detection electrode including a transparent conductive layer,
wherein
the transparent conductive layer includes a plurality of first regions in a crystalline state and a plurality of second regions in an amorphous state that are mixed therein.

[C2] relates to the display device of [C1], wherein
the first regions occupy 50 to 94% of the transparent conductive layer.

[C3] relates to the display device of [C1], wherein
an average value of size of the first regions is in a range from 0.05 to 0.25 μm.

[C4] relates to the display device of [C1] further comprising:
a polarizer located outside the display panel and opposed to the substrate; and
an adhesive layer which bonds the polarizer onto the display panel,
wherein
the detection electrode is located between the substrate and the adhesive layer.

[C5] relates to the display device of [C4], wherein
the polarizer comprises:
a first supporting layer;
a second supporting layer being located between the substrate and the first support layer and having a moisture permeability lower than a moisture permeability of the first supporting layer; and
a polarizer layer located between the first supporting layer and the second supporting layer.

[C6] relates to the display device of [C4], wherein
the polarizer comprises:
a first supporting layer;
a second supporting layer being located between the substrate and the first supporting layer and generating a smaller amount of acid than an amount of acid generated by the first support layer; and
a polarizer layer located between the first supporting layer and the second supporting layer.

[C7] relates to the display device of [C1], further comprising:
an insulating film between the substrate and the detection electrode.

[C8] relates to the display device of [C1], further comprising:
a polarizer located outside the display panel and opposed to the substrate; and
an antistatic layer being located between the detection electrode and the polarizer and having a sheet resistance in a range from 10⁹ to 10¹¹ Ω/□.

[C9] relates to the display device of [C1], further comprising:
a polarizer located outside the display panel and opposed to the substrate; and
a shielding electrode located between the substrate and the polarizer, in a non-display area outside the display area where the detection electrode is disposed,
wherein
a difference between an average potential of the detection electrode an average potential of the shielding electrode is in a range from −1.1 to +1.0V.

[C10] relates to the display device of [C1], further comprising:
a polarizer located outside the display panel and opposed to the substrate,
wherein
the transparent conductive layer extends in a predetermined direction and includes an inclined portion which obliquely crosses the direction, and
the polarizer includes an edge parallel to the direction of the extension of the transparent conductive layer.

[C11] relates to the display device of [C1], further comprising:
a polarizer located outside the display panel and opposed to the substrate,
wherein
the transparent conductive layer includes a slit inclined in a direction within a range of ±45° to a direction along a transmitting axis of the polarizer.

[C12] relates to the display device of [C1], further comprising:
a polarizer located outside the display panel and opposed to the substrate,
wherein
the sensor further comprises a plurality of transparent electrodes, between the substrate and the polarizer, and
most slits, of a plurality of slits formed by the transparent conductive layer and the transparent electrodes, is inclined in a direction within a range of ±45° to a direction along a transmitting axis of the polarizer.

[C13] relates to the display device of [C12], wherein
the transparent electrodes are dummy electrodes.

[C14] relates to the display device of [C1], further comprising:
a first driver which writes a write signal; and
a second driver which reads a read signal,
wherein
the display panel further comprises a common electrode which generates a sensor signal between the common electrode and the detection electrode by writing of the write signal, and
the detection electrode generates the read signal indicating a variation in the sensor signal.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A sensor-equipped display device comprising:
a display panel comprising at least a substrate; and
a sensor comprising a detection electrode including a transparent conductive layer,
wherein
the transparent conductive layer includes a plurality of first regions in a crystalline state and a plurality of second regions in an amorphous state that are mixed therein.

2. The display device of claim 1, wherein
the first regions occupy 50 to 94% of the transparent conductive layer.

3. The display device of claim 1, wherein
an average value of size of the first regions is in a range from 0.05 to 0.25 μm.

4. The display device of claim 1, further comprising:
a polarizer located outside the display panel and opposed to the substrate; and
an adhesive layer which bonds the polarizer onto the display panel,
wherein
the detection electrode is located between the substrate and the adhesive layer.

5. The display device of claim 4, wherein
the polarizer comprises:
a first supporting layer;
a second supporting layer being located between the substrate and the first support layer and having a moisture permeability lower than a moisture permeability of the first supporting layer; and
a polarizer layer located between the first supporting layer and the second supporting layer.

6. The display device of claim 4, wherein
the polarizer comprises:
a first supporting layer;
a second supporting layer being located between the substrate and the first supporting layer and generating a smaller amount of acid than an amount of acid generated by the first support layer; and
a polarizer layer located between the first supporting layer and the second supporting layer.

7. The display device of claim 1, further comprising:
an insulating film between the substrate and the detection electrode.

8. The display device of claim 1, further comprising:
a polarizer located outside the display panel and opposed to the substrate; and
an antistatic layer being located between the detection electrode and the polarizer and having a sheet resistance in a range from 10⁹ to 10¹¹ Ω/□.

9. The display device of claim 1, further comprising:
a polarizer located outside the display panel and opposed to the substrate; and
a shielding electrode located between the substrate and the polarizer, in a non-display area outside the display area where the detection electrode is disposed,
wherein
a difference between an average potential of the detection electrode an average potential of the shielding electrode is in a range from −1.1 to +1.0V.

10. The display device of claim 1, further comprising:
a polarizer located outside the display panel and opposed to the substrate,
wherein
the transparent conductive layer extends in a predetermined direction and includes an inclined portion which obliquely crosses the direction, and
the polarizer includes an edge parallel to the direction of the extension of the transparent conductive layer.

11. The display device of claim 1, further comprising:
a polarizer located outside the display panel and opposed to the substrate,
wherein
the transparent conductive layer includes a slit inclined in a direction within a range of ±45° to a direction along a transmitting axis of the polarizer.

12. The display device of claim 1, further comprising:
a polarizer located outside the display panel and opposed to the substrate,
wherein
the sensor further comprises a plurality of transparent electrodes, between the substrate and the polarizer, and
most slits, of a plurality of slits formed by the transparent conductive layer and the transparent electrodes, is inclined in a direction within a range of ±45° to a direction along a transmitting axis of the polarizer.

13. The display device of claim 12, wherein
the transparent electrodes are dummy electrodes.

14. The display device of claim 1, further comprising:
a first driver which writes a write signal; and
a second driver which reads a read signal,
wherein
the display panel further comprises a common electrode which generates a sensor signal between the common electrode and the detection electrode by writing of the write signal, and
the detection electrode generates the read signal indicating a variation in the sensor signal.
